(19) United States
(12) Patent Application Publication
(10) Pub. No.: US 2008/0139768 A1
(43) Pub. Date: Jun. 12, 2008

(54) Copolymer Having Cyclic Ether Structure in Main Chain, Optical Member Comprising the Copolymer, and Method of Producing the Same

(75) Inventors: Hiroki Sasaki, Kanagawa (JP); Hidetoshi Tomita, Kanagawa (JP); Hirokazu Kyoto, Kanagawa (JP); Kozaburo Yamada, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/630,384

(22) PCT Filed: Jun. 22, 2005
(86) PCT No.: PCT/JP05/11873

§ 371 Date: Aug. 23, 2007

(30) Foreign Application Priority Data
Jun. 24, 2004 (JP) 2004-186199

(51) Int. Cl. C08F 24/00; B32B 7/02

(52) U.S. Cl. 526/257; 526/266; 428/212; 526/256

(57) ABSTRACT

The novel copolymer is disclosed. The copolymer comprises 1 to 99 mol % of at least one repetitive unit (P1) of the formula (1) and 99 to 1 mol % of at least one repetitive unit (P2) of the formula (2). In the formulae, R¹ to R⁴ and L¹ to L⁴ respectively represent a hydrogen atom, a deuterium atom, a halogen atom or any substituent; X and Y respectively represent an oxygen atom or sulfur atom, n1 represents any one of integers from 2 to 4, and 1 and m respectively represents the number of repetition of the repetitive unit, provided that at least one of R¹ to R⁴ is not a fluorine atom (F) and at least one of L¹ to L⁴ contains one or more fluorine atoms, any two groups selected from L¹ to L⁴ may form a cyclic structure.

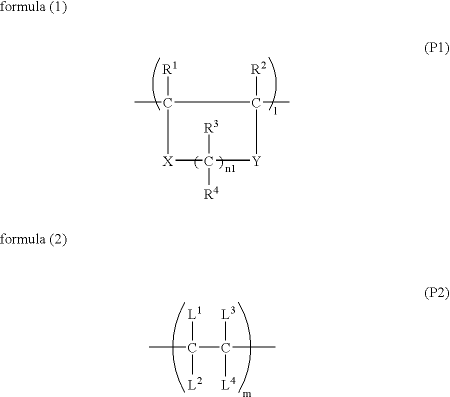

### TECHNICAL FIELD

The present invention relates to a novel copolymer having a cyclic ether structure. The present invention belongs to technical fields of plastic optical members, in particular to technical fields of optical members preferably used as optical fibers, optical waveguides, optical lenses and so forth, a copolymer used for producing the optical members, and a method of producing the same.

### BACKGROUND ART

Plastic optical members are advantageous over the conventional glass optical members of the same structure, in terms of simplicity in the fabrication and processing, and of inexpensiveness, so that much efforts have been made in recent years for applying them to optical fiber, optical lens, optical waveguide and so forth. Of these optical members, plastic optical fiber (occasionally abbreviated as POF, hereinafter), of which entire portion is formed of plastic material, has the advantages of good flexibility, light weight, good workability, easiness for forming into a large-diameter fiber as compared with glass optical fiber, and inexpensiveness of the production cost, despite some disadvantages in the transmission loss slightly larger than that of the glass one. The plastic optical fiber is therefore extensively investigated as a transmission media for short-distance optical communication in which the transmission loss is negligible.

In the field of plastic optical members, there are known various polymers having a cyclic structure in their main chains. One of purposes of introducing a cyclic structure is to raise heat resistance, that is, to raise glass transition point (Tg) of the polymer. Representative polymers having a cyclic structure in their main chains include (1) polymers mainly having aromatic groups and polar groups such as polyester, polyamide, polyimide, polycarbonate, etc.; (2) polymers produced according to cyclic polymerization (Japanese Patent No. 2526641); (3) polymers according to ring-opening polymerization (amorphous polyolefin) (Japanese Examined Patent Publication No. 8-26124, ditto No. 2-9619); and (4) copolymers of cyclic monomers and different olefins (Japanese Laid-Open Patent Publication No. 5-25337, ditto No. 2001-122928, ditto No. 2003-155312, “TEFLON (Registered trademark) AF Amorphous Fluoropolymer”, Modern Fluoropolymers, John Scheires (Ed.), John Wiley & Sons, Ltd., p. 397-398 (1997). With regard to the polymers (1), by introductions of aromatic groups or polar groups, Tg of the polymers may be increased, but birefringence and hygroscopicity of some of the polymers (1) may be increased ascribable to molecular orientation. With regard to the polymers (2) related to the cyclic polymerization systems, they may become insoluble by crosslinking because the monomers thereof generally have diene structure, and are difficult to have a ring formation ration and a polymerization yield in a balanced manner. Another problem relates to perfluorated (diene) monomers, of which synthesis is difficult (several synthetic steps required) and time-consuming (Japanese Patent No. 2526641, “TEFLON (Registered trademark) AF Amorphous Fluoropolymer”, Modern Fluoropolymers, John Scheires (Ed.), John Wiley & Sons, Ltd., p. 397-398 (1997). The source materials therefor are generally not readily available, and the synthesis needs hazardous reagents, and this pushes up costs of the polymer. Furthermore, all-fluorine-type polymers are insoluble to general solvents, and this inevitably forces use of special fluorine-containing solvents. With regard to the polymers (3) related to the ring-opening polymerization systems, some are successfully improved in birefringence and hygroscopicity, by minimizing as possible contents of the aromatic groups and polar groups. Reduction in the hygroscopicity may, however, degrade adhesiveness with other layers. They are under discussion of introducing some functional groups, because they are poor in the degree of structural freedom. With regard to the copolymers (4) produced by polymerization of cyclic monomers and different olefins are extensively investigated, with expectations of easy manufacturing and possibility of widening adjustable ranges of the physical properties. Among others, there is disclosed a copolymer of a fluorine-containing cyclic olefin, such as octafluorocyclopentene composed of carbon atoms and fluorine atoms, and a different olefin (Japanese Laid-Open Patent Publication No. 2001-122928), wherein the fluorine-containing cyclic olefins of different structures cannot readily be available, because the monomers thereof can only be synthesized by special processes similarly to the perfluorated diene monomer. On the other hand, there is disclosed a copolymer of vinylene carbonate and a fluorine-containing olefin (more specifically, tetrafluoroethylene (occasionally abbreviated as TFE) and chlorotrifluoroethylene (occasionally abbreviated as CTFE) (Japanese Laid-Open Patent Publication No. 2003-155312), wherein increase in the content of vinylene carbonate in the polymer results in increase in the polarity, and this may make the polymer more susceptible to moistening. The copolymer, which is a random copolymer, is much likely to show crystallinity depending on the polymerization process or contents of vinylene carbonate, and this is disadvantageous for applications where transparency is required. There is also disclosed a fluorine-containing copolymer having 1,3-dioxol derivatives, only showing a poor stability or the polymer under wet heating (Japanese Laid-Open Patent Publication No. 4-292608). In conclusion, there are still demands on polymers generally satisfactory in terms of good wet-heating resistance and amorphous keeping property.

### DISCLOSURE OF THE INVENTION

It is therefore an object of the present invention to provide a novel copolymer exhibiting a wet-heating resistance and a non-crystalline property. It is another object of the present invention to provide a process for producing the above-described copolymer, and an optical member comprising the copolymer as a major component, and exhibiting a good heat resistance and good optical characteristics.

In one aspect, the present invention provides a copolymer comprising 1 to 99 mol % of a repetitive unit (P1) represented by the formula (1) below:

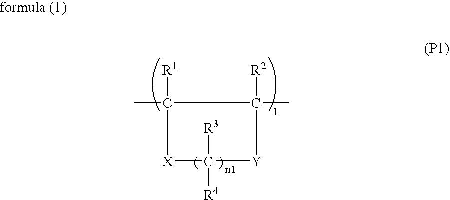

where, R¹ and R² respectively represent a hydrogen atom (H), a deuterium atom (D), a halogen atom, a substituted or non-substituted alkyl group or a substituted or non-substituted aryl group; R³ and R⁴ respectively represent a hydrogen atom (H), a deuterium atom (D), a halogen atom, a cyano group, a nitro group or a substituted or non-substituted alkyl group, aryl group, alkoxy group, aryloxy group, heterocyclic oxy group, alkoxy or aryloxycarbonyl group, alkyl or arylcarbonyloxy group, carbamoyl group, alkyl or arylaminocarbonyl group, acylamino group, alkyl or arylcarbonylamino group, alkoxy or aryloxycarbonyloxy group, alkoxy or aryloxycarbonylamino group, alkyl or arylsulfonylamino group, alkyl or arylthio group, heterocyclic thio group, alkyl or arylsulfinyl group, alkyl or arylsulfonyl group or acyl group; X and Y respectively represent an oxygen atom (O) or sulfur atom (S), n1 represents any one of integers from 2 to 4, and 1 represents the number of repetition of the repetitive unit, provided that at least one of R¹ to R⁴ is not a fluorine atom (F); and 99 to 1 mol % of a repetitive unit (P2) represented by the formula (2) below:

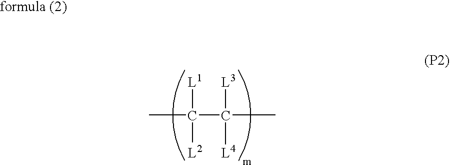

where, L¹ to L⁴ respectively represent a hydrogen atom (H), a deuterium atom (D), a halogen atom, a cyano group, a nitro group or a substituted or non-substituted alkyl group, aryl group, alkoxy group, aryloxy group, alkoxy or aryloxycarbonyl group, alkyl or arylcarbonyloxy group, carbamoyl group, alkyl or arylaminocarbonyl group, acyl group, acylamino group, alkyl or arylcarbonylamino group, alkoxy or aryloxycarbonyloxy group, alkoxy or aryloxycarbonylamino group, or alkyl or arylsulfonylamino group, provided that at least one of L¹ to L⁴ contains one or more fluorine atoms, any two groups selected from L¹ to L⁴ may form a cyclic structure, and m represents the number of repetition of the repetitive unit.

As embodiments of the invention, the copolymer wherein R¹ and R² in the formula (1) respectively represent a hydrogen atom (H) or deuterium atom (D); the copolymer wherein both of X and Y in the formula (1) represent an oxygen atom (O), and n1 is 2; and the copolymer wherein the repetitive unit (P1) is represented by the formula (5a) below:

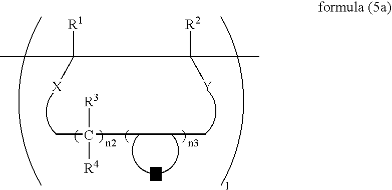

where R¹ to R⁴, and X, Y and 1 are respectively same with those in the formula (1); n2 represents 0 or 1, and n3 represents 1 or 2, excluding the case where n2 is 1 and n3 is 2; and Q represents a substituted or non-substituted aliphatic hydrocarbon ring or aromatic hydrocarbon ring condensed with the main ring; are provided.

In another aspect, the present invention provides a copolymer, having a molecular weight of 1,000 to 1,000,000 (styrene-based number average molecular weight measured by gel permeation chromatography), of 1 to 99 mol % of a monomer (M1) represented by the formula (3) below;

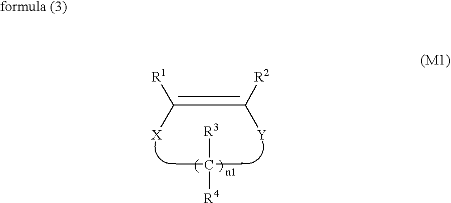

where, R¹ and R² respectively represent a hydrogen atom (H), a deuterium atom (D), a halogen atom, a substituted or non-substituted alkyl group or a substituted or non-substituted aryl group; R³ and R⁴ respectively represent a hydrogen atom (H), a deuterium atom (D), a halogen atom, a cyano group, a nitro group, or a substituted or non-substituted alkyl group, aryl group, alkoxy group, aryloxy group, heterocyclic oxy group, alkoxy or aryloxycarbonyl group, alkyl or arylcarbonyloxy group, carbamoyl group, alkyl or arylaminocarbonyl group, acylamino group, alkyl or arylcarbonylamino group, alkoxy or aryloxycarbonyloxy group, alkoxy or aryloxycarbonylamino group, alkyl or arylsulfonylamino group, alkyl or arylthio group, heterocyclic thio group, alkyl or arylsulfinyl group, alkyl or arylsulfonyl group or acyl group; X and Y respectively represent an oxygen atom (O) or sulfur atom (S); and n1 represents any one of integers from 2 to 4, provided that at least one of R¹ to R⁴ is not a fluorine atom (F); and 99 to 1 mol % of a monomer (M2) represented by the formula (4) below:

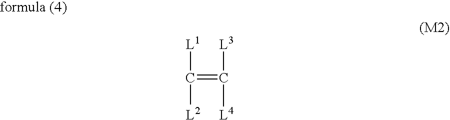

where, L¹ to L⁴ respectively represent a hydrogen atom (H), a deuterium atom (D), a halogen atom, a cyano group, a nitro group, or a substituted or non-substituted alkyl group, aryl group, alkoxy group, aryloxy group, alkoxy or aryloxycarbonyl group, alkyl or arylcarbonyloxy group, carbamoyl group, alkyl or arylaminocarbonyl group, acyl group, acylamino group, alkyl or arylcarbonylamino group, alkoxy or aryloxycarbonyloxy group, alkoxy or aryloxycarbonylamino group, or alkyl or arylsulfonylamino group, provided that at least one of L¹ to L⁴ contains one or more fluorine atoms, any two groups selected from L¹ to L⁴ may form a cyclic structure.

In another aspect, the present invention provides a process for producing an optical member comprising carrying out polymerization of 1 to 99 mol % of at least one monomer (M1) represented by the formula (3) above and 99 to 1 mol % of at least one monomer (M2) represented by the formula (4) above.

In another aspect, the present invention provides an optical member comprising at least one region comprising the copolymer as set forth above as a major component.

As embodiment of the present invention, the optical member wherein the region comprises at least a first layer and a second layer, the first layer comprises the copolymer of the monomer (M1) and the monomer (M2) in a molar ratio r1, the second layer comprises the copolymer of the monomer (M1) and the monomer (M2) in a molar ratio r2, which is not equal to r1, the refractive indices of the first and second layers are different each other based on a difference between the r1 and the r2, is provided.

### DETAILED DESCRIPTION OF THE INVENTION

The copolymer of the present invention, the process for producing the copolymer and the optical member comprising the copolymer as a major component will be described in detail. It is noted that, in the specification, ranges indicated with “to” mean ranges including the numerical values before and after “to” as the minimum and maximum values.

First, the copolymer of the present invention and a process for producing the copolymer will be described in detail.

The copolymer of the present invention comprises a repetitive unit (P1) represented by the formula (1) below and a repetitive unit (P2) represented by the formula (2) below. The copolymer of the present invention is preferably non-crystalline.

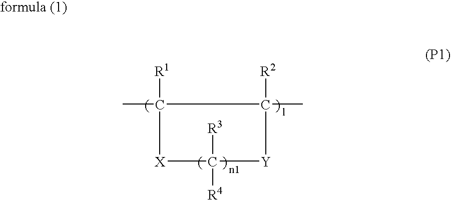

In the formula, R¹ and R² respectively represent a hydrogen atom (H), a deuterium atom (D), a halogen atom, a substituted or non-substituted alkyl group or a substituted or non-substituted aryl group; R³ and R⁴ respectively represent a hydrogen atom (H), a deuterium atom (D), a halogen atom, a cyano group, a nitro group or a substituted or non-substituted alkyl group, aryl group, alkoxy group, aryloxy group, heterocyclic oxy group, alkoxy or aryloxycarbonyl group, alkyl or arylcarbonyloxy group, carbamoyl group, alkyl or arylaminocarbonyl group, acylamino group, alkyl or arylcarbonylamino group, alkoxy or aryloxycarbonyloxy group, alkoxy or aryloxycarbonylamino group, alkyl or arylsulfonylamino group, alkyl or arylthio group, heterocyclic thio group, alkyl or arylsulfinyl group, alkyl or arylsulfonyl group or acyl group; X and Y respectively represent an oxygen atom (O) or sulfur atom (S), n1 represents any one of integers from 2 to 4, and 1 represents the number of repetition of the repetitive unit, provided that at least one of R¹ to R⁴ is not a fluorine atom (F).

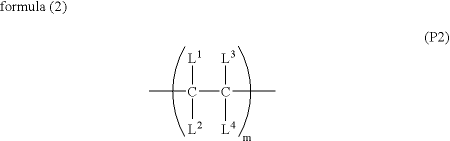

In the formula, L¹ to L⁴ respectively represent a hydrogen atom (H), a deuterium atom (D), a halogen atom, a cyano group, a nitro group or a substituted or non-substituted alkyl group, aryl group, alkoxy group, aryloxy group, alkoxy or aryloxycarbonyl group, alkyl or arylcarbonyloxy group, carbamoyl group, alkyl or arylaminocarbonyl group, acyl group, acylamino group, alkyl or arylcarbonylamino group, alkoxy or aryloxycarbonyloxy group, alkoxy or aryloxycarbonylamino group, or alkyl or arylsulfonylamino group, provided that at least one of L¹ to L⁴ contains one or more fluorine atoms, any two groups selected from L¹ to L⁴ may form a cyclic structure, and m represents the number of repetition of the repetitive unit.

This means that, as shown below, P1 in the copolymer of the present invention is obtained by polymerizing a monomer (M1) represented by the formula (3) below, and P2 is obtained by polymerizing a monomer (M2) represented by the formula (4) below.

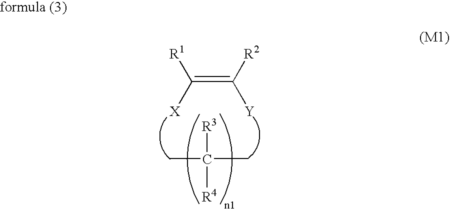

In the formula, R¹ and R² respectively represent a hydrogen atom (H), a deuterium atom (D), a halogen atom, a substituted or non-substituted alkyl group or a substituted or non-substituted aryl group; R³ and R⁴ respectively represent a hydrogen atom (H), a deuterium atom (D), a halogen atom, a cyano group, a nitro group, or a substituted or non-substituted alkyl group, aryl group, alkoxy group, aryloxy group, heterocyclic oxy group, alkoxy or aryloxycarbonyl group, alkyl or arylcarbonyloxy group, carbamoyl group, alkyl or arylaminocarbonyl group, acylamino group, alkyl or arylcarbonylamino group, alkoxy or aryloxycarbonyloxy group, alkoxy or aryloxycarbonylamino group, alkyl or arylsulfonylamino group, alkyl or arylthio group, heterocyclic thio group, alkyl or arylsulfinyl group, alkyl or arylsulfonyl group or acyl group; X and Y respectively represent an oxygen atom (O) or sulfur atom (S); and n1 represents any one of integers from 2 to 4, provided that at least one of R¹ to R⁴ is not a fluorine atom (F);

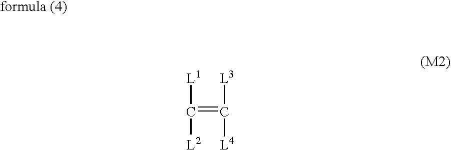

In the formula, L¹ to L⁴ respectively represent a hydrogen atom (H), a deuterium atom (D), a halogen atom, a cyano group, a nitro group, or a substituted or non-substituted alkyl group, aryl group, alkoxy group, aryloxy group, alkoxy or aryloxycarbonyl group, alkyl or arylcarbonyloxy group, carbamoyl group, alkyl or arylaminocarbonyl group, acyl group, acylamino group, alkyl or arylcarbonylamino group, alkoxy or aryloxycarbonyloxy group, alkoxy or aryloxycarbonylamino group, or alkyl or arylsulfonylamino group, provided that at least one of L¹ to L⁴ contains one or more fluorine atoms, any two groups selected from L¹ to L⁴ may form a cyclic structure; to form a copolymer having a molecular weight of 1,000 to 1,000,000 (styrene-based number average molecular weight measured by gel permeation chromatography).

The monomer (M1) will be explained first.

In formula (3), R¹ and R² respectively represent a hydrogen atom (H), a deuterium atom (D), a halogen atom, a substituted or non-substituted alkyl group or a substituted or non-substituted aryl group.

In the formula (3), R³ and R⁴ respectively represent a hydrogen atom (H), a deuterium atom (D), a halogen atom, a cyano group, a nitro group, a substituted or non-substituted alkyl group, aryl group, alkoxy group, aryloxy group, heterocyclic oxy group, alkoxycarbonyl group, aryloxycarbonyl group, alkylcarbonyloxy group, arylcarbonyloxy group, carbamoyl group, alkylaminocarbonyl group, arylaminocarbonyl group, acylamino group, alkylcarbonylamino group, arylcarbonylamino group, alkoxycarbonyloxy group, aryloxycarbonyloxy group, alkoxycarbonylamino group, aryloxycarbonylamino group, alkylsulfonylamino group, arylsulfonylamino group, alkylthio group, arylthio group, heterocyclic thio group, alkylsulfinyl group, arylsulfinyl group, alkylsulfonyl group, arylsulfonyl group, or acyl group.

The alkyl group may be any of straight-chain, branched and cyclic ones. The straight-chain or branched alkyl group preferably has the number of carbon atoms of 1 to 30, and more preferably 1 to 10. Examples of substituted or non-substituted, straight-chain or branched alkyl groups include methyl, ethyl, n-propyl, isopropyl, t-butyl, n-octyl, eicosyl, 2-chloroethyl, 2-cyanoethyl, 2-ethylhexyl, trifluoromethyl, trifluoroethyl, pentafluoropropyl, heptafluorobutyl, tetrafluoropropyl, octafluoropentyl, hexafluoroisopropyl, benzyl, phenylethyl, methylbenzyl, and naphthylmethyl. Monocycloalkyl group is preferably selected from non-substituted cycloalkyl groups having the number of carbon atoms of 3 to 30. Examples of the monocycloalkyl group include cyclohexyl, cyclopentyl, and 4-n-dodecylcyclohexyl. Bicycloalkyl group preferably has the number of carbon atoms of 5 to 30. Or in other words, bicycloalkyl group is preferably selected from monovalent residues obtained by eliminating one hydrogen atom from bicycloalkanes having the number of carbon atoms of 5 to 30. Examples of the bicycloalkyl group include norbornyl group, isobornyl group and adamanthyl group. Examples of tricycloalkyl group, having a larger number of the cyclic structure, includes dicyclopentanyl group.

The aryl group contains one or more aromatic rings which may be monocycle or condensed. Examples of the aryl group include phenyl group, methylphenyl group, pentafluorophenyl group, tribromophenyl group, pentabromophenyl group, mesityl group, p-methoxyphenyl group, and naphthyl group.

The alkyl group or aryl group represented by each of R¹ to R⁴, or the alkyl group or aryl group included in any substituent groups represented by each of R¹ to R⁴ may further have a substituent, wherein examples of such substituent include halogen atom, alkyl group (including cycloalkyl group having one or more cyclic structures such as monocycloalkyl group and bicycloalkyl group), alkenyl group (including cycloalkenyl group and bicycloalkenyl group), alkynyl group, aryl group, heterocyclic group, cyano group, hydroxyl group, nitro group, carboxyl group, alkoxy group, aryloxy group, silyloxy group, heterocyclic oxy group, acyloxyl group, carbamoyloxy group, alkoxycarbonyloxy group, aryloxycarbonyloxy group, amino group (including anilino group), acylamino group, aminocarbonylamino group, alkoxycarbonylamino group, aryloxycarbonylamino group, sulfamoylamino group, alkylsulfonylamino group, arylsulfonylamino group, mercapto group, alkylthio group, arylthio group, heterocyclic thio group, sulfamoyl group, sulfo group, alkylsulfinyl group, arylsulfinyl group, alkylsulfonyl group, arylsulfonyl group, acyl group, aryloxycarbonyl group, alkoxycarbonyl group, carbamoyl group, aryl and heterocyclic azo group, imido group, phosphino group, phosphinyl group, phosphinyloxy group, phosphinylamino group, and silyl group.

It should be noted that at least one of R¹ to R⁴ is not a fluorine atom (F), or in other words, that the monomers represented by the formula (3) wherein all of R¹ to R⁴ are fluorine atoms are excluded from the monomer (M1). For the case where any alkyl group or aryl group is contained in R¹ to R⁴, at least a part of C—H bonds in these groups may be replaced by C-D bonds. It should be also noted that R¹ to R⁴ do not have polymerizable groups.

It is preferable that each of R¹ and R² independently represents a hydrogen atom (H), a deuterium atom (D) or a halogen atom, and it is more preferable that each of R¹ and R² independently represents a hydrogen atom (H) or a deuterium atom (D).

It is preferable that each of R³ and R⁴ independently represents a hydrogen atom (H), a deuterium atom (D), a halogen atom or a substituted or non-substituted alkyl group, aryl group, alkoxy group, aryloxy group, alkylthio group or arylthio group; and it is more preferable that each of R³ and R⁴ independently represents a hydrogen atom (H), a deuterium atom (D), a halogen atom or substituted or a non-substituted alkyl group or aryl group.

Each of X and Y independently represents an oxygen atom (O) or sulfur atom (S). It is preferable that at least either one of X and Y represents O, and it is most preferable that the both represent O.

n1 represents an integers from 2 to 4. It is preferable that n1 represents an integer of 2 or 3, and it is particularly preferable that n1 represents 2.

When n1 represents an integer from 2 to 4, the monomer represented by the formula (3) may have a multi-ring structure represented by the formula (5) below. More specifically, groups R³ or R⁴ bound on the adjacent carbon atoms may bind to form a ring, to thereby make the ring in the formula (3) have a condensed-ring structure.

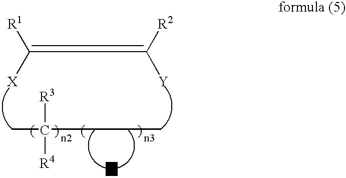

In the formula, R¹ to R⁴, and X and Y in the formula (5) are respectively same with those in the formula (3). n2 represents 0 or 1, and n3 represents 1 or 2, excluding the case where n2 is 1 and n3 is 2. The ring Q condensed with the main ring may be a substituted or non-substituted, aliphatic hydrocarbon ring or aromatic hydrocarbon ring. n2 is preferably 0.

The aliphatic hydrocarbon ring represented by Q may be either of monocyclic system and polycyclic system. The aliphatic hydrocarbon ring may be substituted or non-substituted. The aliphatic hydrocarbon ring represented by Q is preferably a substituted or non-substituted aliphatic hydrocarbon ring having the number of carbon atoms of 3 to 30. Examples of the monocyclic aliphatic hydrocarbon ring include cyclohexane ring, cyclopentyl ring, and 4-n-dodecylcyclohexane ring. The polycyclic aliphatic hydrocarbon ring represented by Q preferably has the number of carbon atoms of 5 to 30. Examples of the polycyclic aliphatic hydrocarbon ring include norbornene ring, isobornene ring and adamantane ring. Examples of the polycyclic aliphatic hydrocarbon ring containing a larger number of rings include dicyclopentane ring. Among these, cyclohexane ring or norbornene ring is more preferable.

The aromatic hydrocarbon ring represented by Q may be either of monocyclic system and polycyclic system. The aromatic hydrocarbon ring may be substituted or non-substituted. Examples of the aromatic hydrocarbon ring include benzene ring, substituted benzene ring (e.g., methyl-substituted toluene ring and mesitylene ring; halogen-atom-substituted tetrafluorobenzene ring, tribromobenzene ring and tetrabromobenzene ring; methoxy-substituted methoxybenzene ring), and naphthalene ring. Among these, non-substituted benzene ring, toluene ring, tetrafluorobenzene ring and p-methoxybenzene ring are preferable, and non-substituted benzene ring is more preferable.

The compounds represented by the formula (3) can be synthesized by a variety of method. According to the processes described in Japanese Laid-Open Patent Publication Nos. 10-67773 and 2-167275, 1,4-dioxene can be synthesized.

Specific examples of the compounds represented by the formula (3) will be listed below, without limiting the compounds represented by the formula (3) applicable to the present invention. It is also to be noted that hydrogen atoms (any unillustrated hydrogen atoms included) may be either of ¹H and ²H.

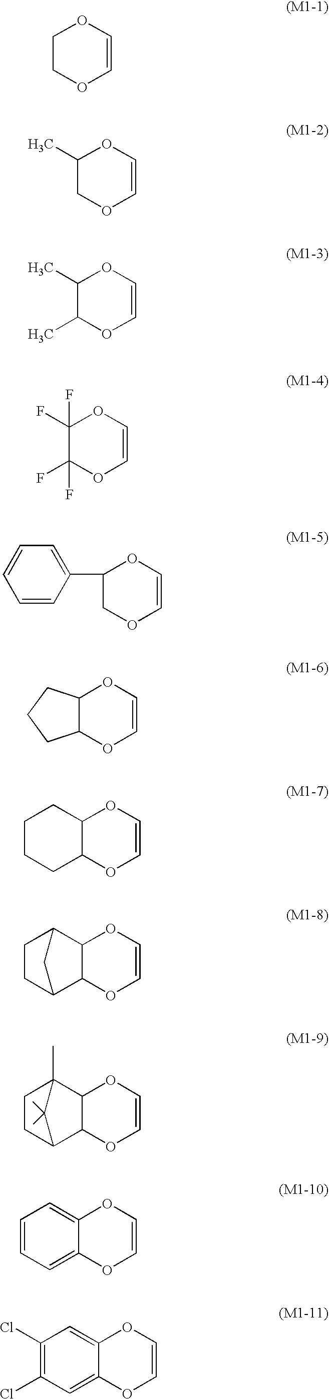

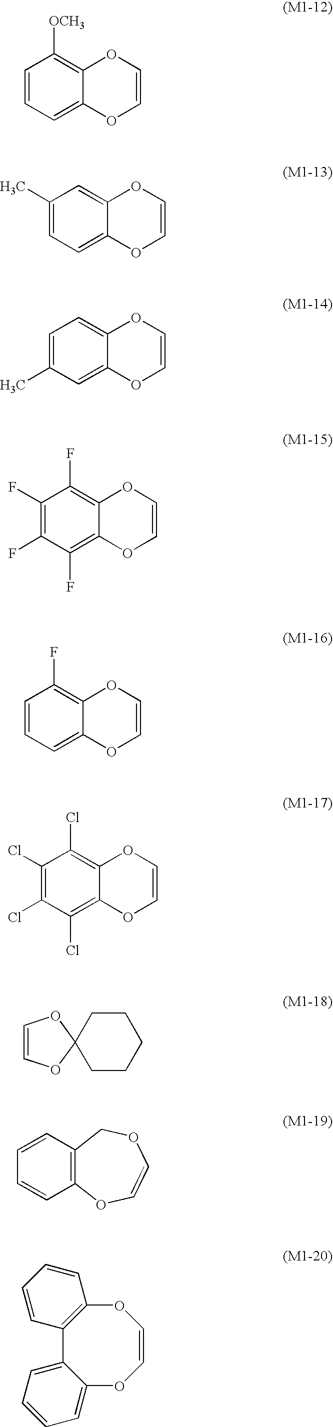

Next paragraphs will describe the monomer M2 represented by the formula (4).

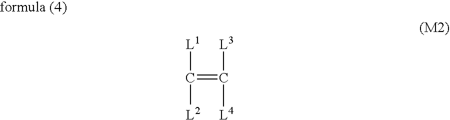

In the formula, L¹ to L⁴ respectively represent a hydrogen atom (H), a deuterium atom (D), a halogen atom, a cyano group, a nitro group, or a substituted or non-substituted alkyl group, aryl group, alkoxy group, aryloxy group, alkoxy or aryloxycarbonyl group, alkyl or arylcarbonyloxy group, carbamoyl group, alkyl or arylaminocarbonyl group, acyl group, acylamino group, alkyl or arylcarbonylamino group, alkoxy or aryloxycarbonyloxy group, alkoxy or aryloxycarbonylamino group, or alkyl or arylsulfonylamino group. It should be noted that at least one of L¹ to L⁴ contains one or more fluorine atoms.

The monomer M2 represented by the formula (4) is preferably an electron-attractive monomer. There is known Q, e-Scheme as an index for estimating polymerization activity of vinyl monomer, proposed by Alfrey and Price. Explanations or values of Q, e-Scheme of various monomers can be referred to Polymer Handbook (2nd edition, co-edited by J. Brandrup and E. H. Immergut). The values can also experimentally be estimated. The e value of the monomer M2 represented by the formula (4) is preferably 0 or larger, and more preferably 0.2 or larger. Also from this point of view, the monomer M2 preferably contains fluorine atom, and more preferably two or more fluorine atoms. There are no special limitations on the Q value, but preferably 3 or smaller, more preferably 2 or smaller, and still more preferably 1 or smaller, because it is particularly preferable to form an alternative copolymer with the monomer M1 represented by the formula (3). Any two groups selected from L¹ to L⁴ may form a cyclic structure.

The alkyl group or aryl group represented by L¹ to L⁴, and the alkyl group or aryl group contained in the substituent groups represented by L¹ to L⁴ may be substituted with any group, wherein examples of the substituent group are same as those exemplified in connection with the formula (3).

It is preferable that L¹ and L² respectively represent a hydrogen atom (H), a deuterium atom (D) or a halogen atom (more preferably a fluorine atom (F)), L³ represents a fluorine atom or CF₃ and L⁴ represents a halogen atom, a substituted with at least one halogen atom (more preferably fluorine atom) alkoxy group or a substituted with at least one halogen atom (more preferably fluorine atom) alkyloxycarbonyl group.

For the case where L¹ to L⁴ contain an alkyl group or aryl group, a part of the C—H bonds contained therein may be C-D bonds. L¹ to L⁴ do not include polymerizable groups.

Most of the compounds represented by the formula (4) are commercially available, and also derivatives thereof can be synthesized by known procedures.

Specific examples of the compounds represented by the formula (4) will be listed below, without limiting the compounds represented by the formula (4) applicable to the present invention. It is also to be noted that hydrogen atoms (any unillustrated hydrogen atoms included) may be either of ¹H and ²H (or D).

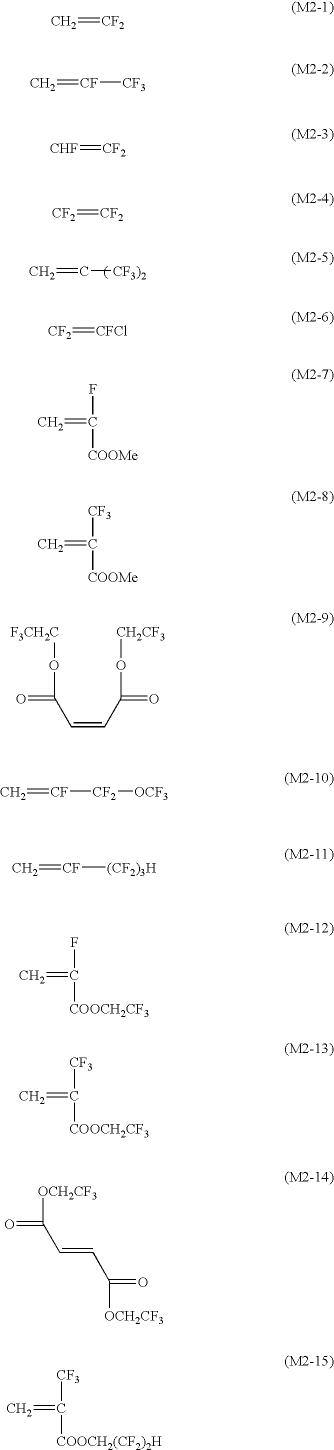

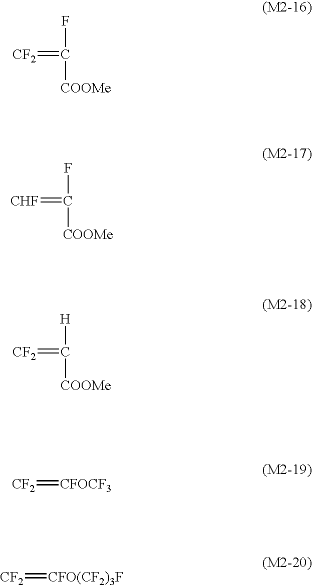

Q,e values of some of the compounds from those represented by the formula (4) are described in a literature (“Fusso-kei Porima no Kaihatsu to Yoto Tenkai (Japanese: Development and Applications of Fluorine-Containing Polymers)”, published by Technical Information Institute, Co., Ltd., 1991).

Next paragraphs will describe the copolymer of the monomers (M1) and (M2). The copolymer of the present invention is a copolymer (preferably a non-crystalline copolymer) of 1 to 99 mol % of the monomer (M1) represented by the formula (3), and 99 to 1 mol % of the monomer (M2) represented by the formula (4). The copolymer is more preferably a non-crystalline copolymer of 30 to 70 mol % of the monomer M1 and 70 to 30 mol % of the monomer M2, and more preferably a non-crystalline copolymer of 40 to 60 mol % of the monomer M1 and 60 to 40 mol % of the monomer M2. It is also allowable to select and use a plurality of species respectively from the monomers represented by the formulae (3) and (4).

Specific examples of the copolymers of the present invention will be listed below, without limiting the copolymers of the present invention. It is also to be noted that hydrogen atoms (any unillustrated hydrogen atoms included) may be either of ¹H and ²H.

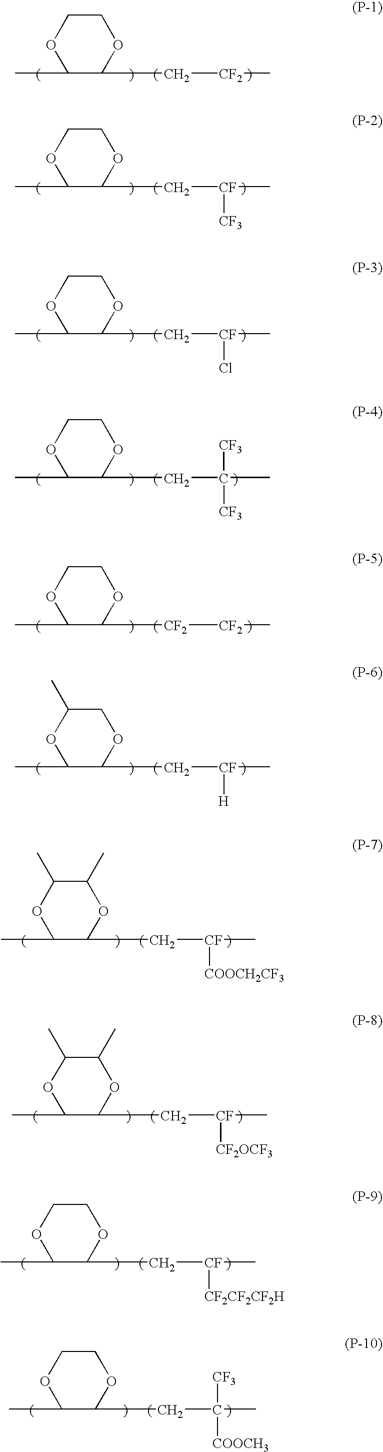

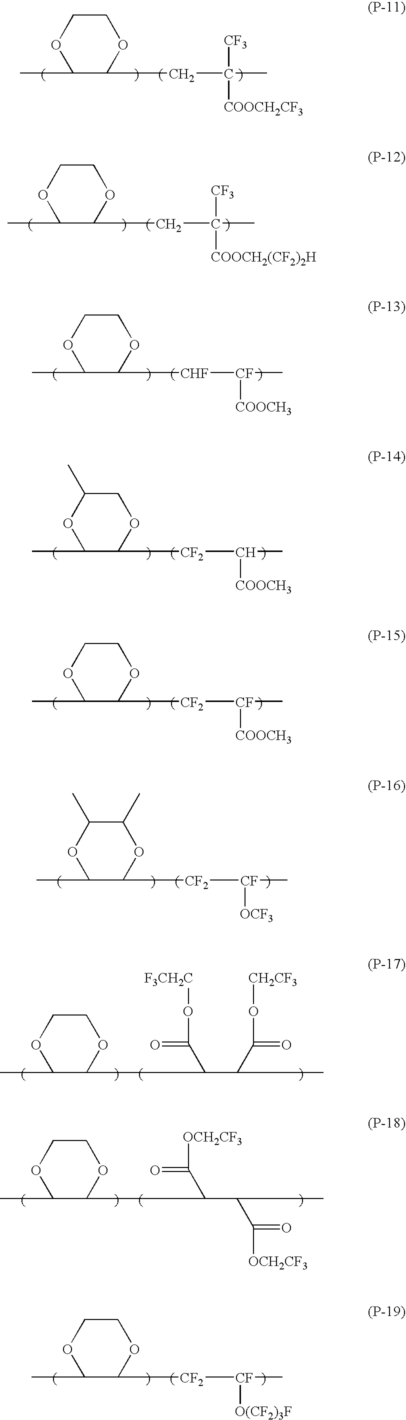

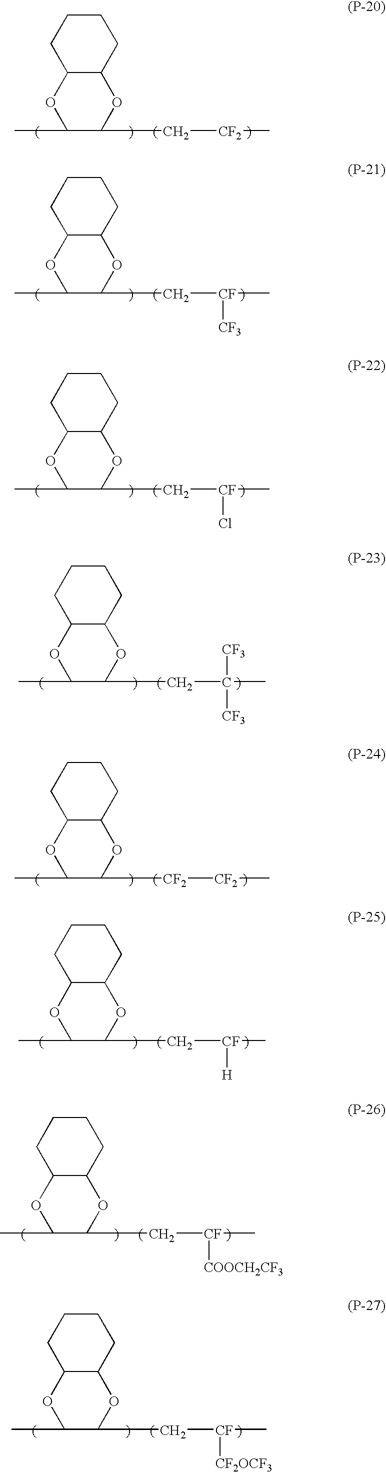

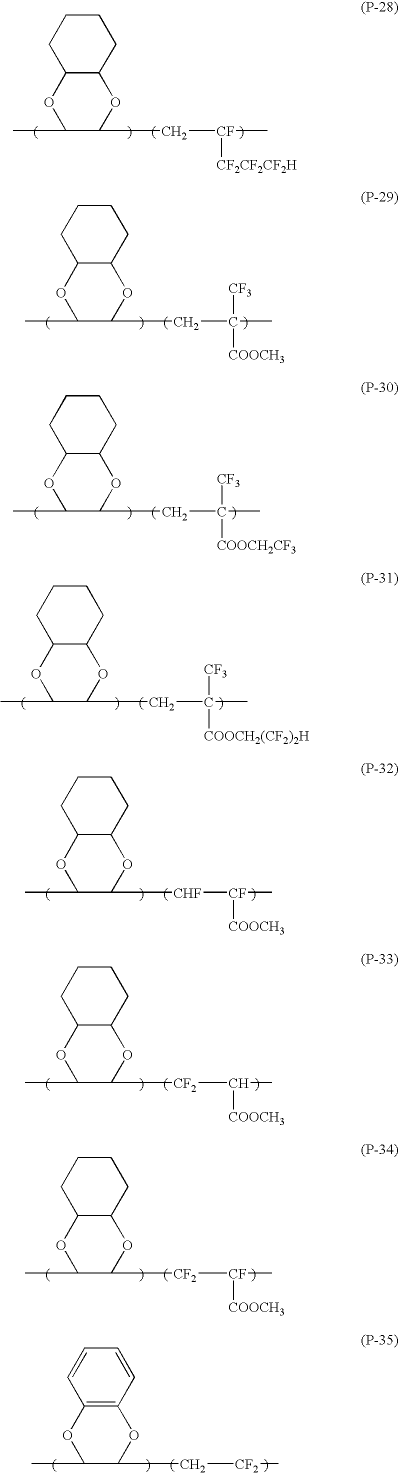

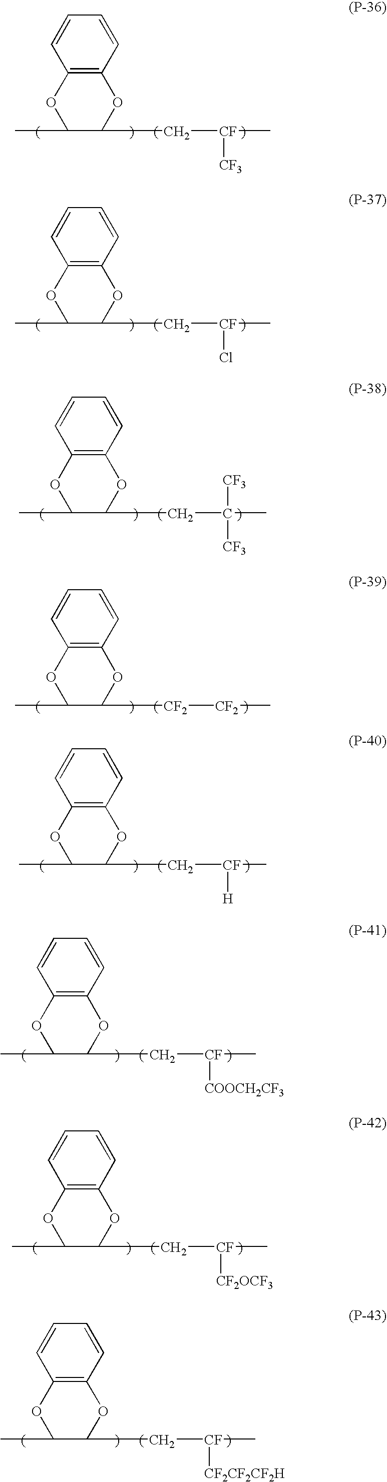

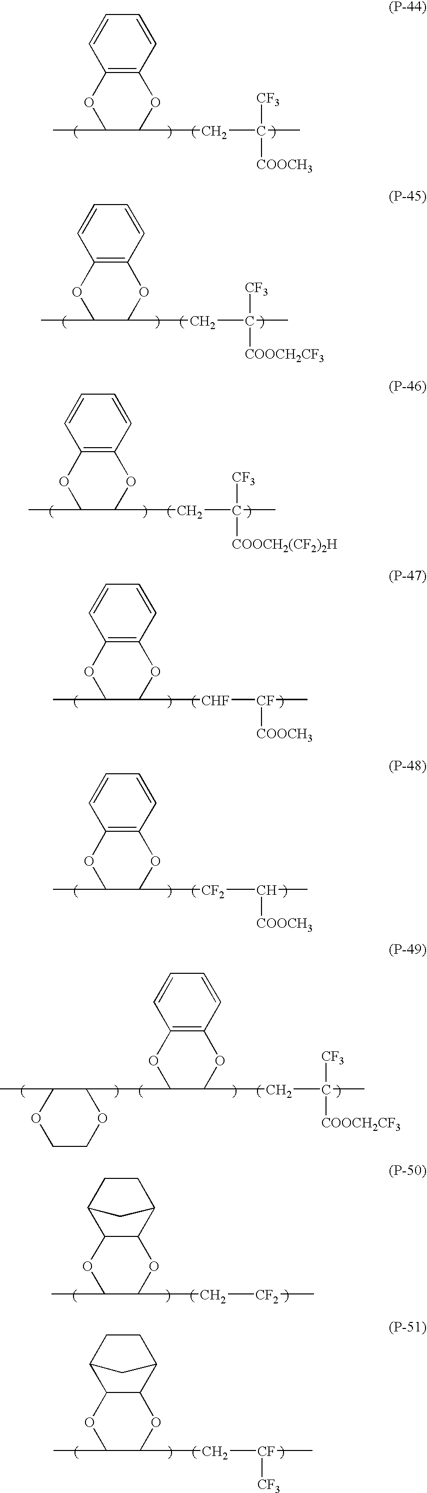

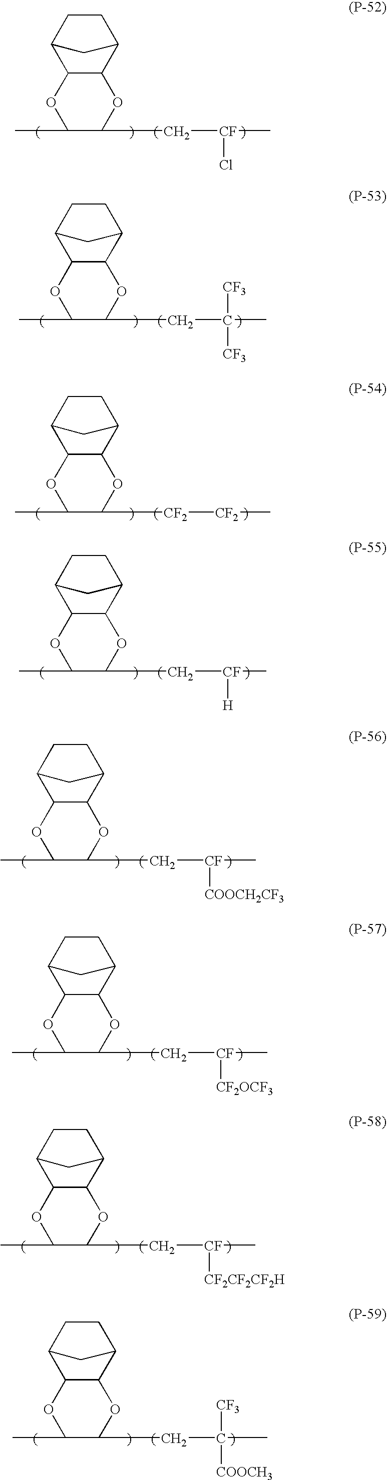

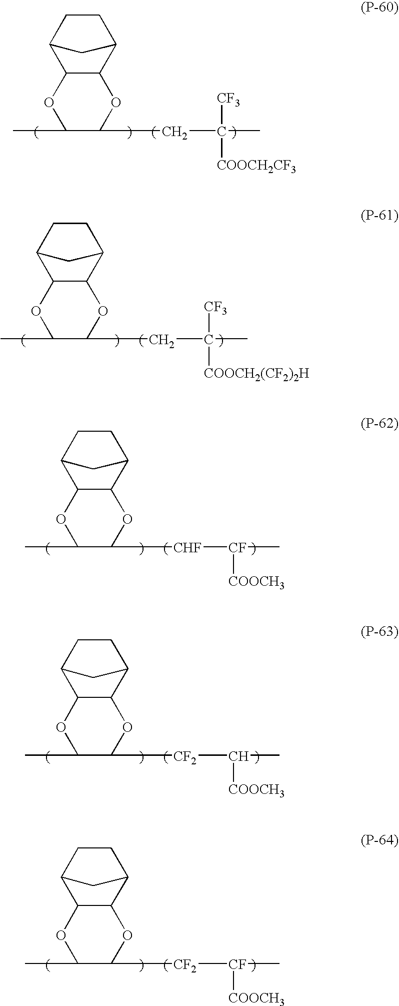

The above-described copolymer can be manufactured by any known polymerization processes. Examples of such methods include bulk polymerization, solution polymerization, emulsion polymerization in water or emulsion, and suspension polymerization. An appropriate process of polymerization is selected depending on required performances of optical members to which the copolymer is applied. For example, bulk polymerization is preferably employed for producing core materials of plastic optical fibers, and a process is appropriately selected from bulk polymerization, solution polymerization, emulsion polymerization and suspension polymerization for producing cladding materials of such fiber.

Examples of solvent generally used for the solution polymerization include ethyl acetate, methyl acetate and butyl acetate.

Polymerization initiator can appropriately be selected depending on the monomers or the polymerization process to be employed, and examples thereof include peroxide compounds such as benzoyl peroxide (BPO), tert-butylperoxy-2-ethylhexanate (PBO), di-tert-butylperoxide (PBD), tert-butylperoxyisopropyl carbonate (PBI) and n-butyl 4,4-bis(tert-butylperoxy)valerate (PHV); and azo compounds such as 2,2′-azobisisobutylonitrile, 2,2′-azobis(2-methylbutylonitrile), 1,1′-azobis(cyclohexane-1-carbonitrile), 2,2′-azobis(2-methylpropane), 2,2′-azobis(2-methylbutane), 2,2′-azobis(2-methylpentane), 2,2′-azobis(2,3-dimethylbutane), 2,2′-azobis(2-methylhexane), 2,2′-azobis(2,4-dimethylpentane), 2,2′-azobis(2,3,3-trimethylbutane), 2,2′-azobis(2,4,4-trimethylpentane), 3,3′-azobis(3-methylpentane), 3,3′-azobis(3-methylhexane), 3,3′-azobis(3,4-dimethylpentane), 3,3′-azobis(3-ethylpentane), dimethyl-2,2′-azobis(2-methylpropionate), diethyl-2,2′-azobis(2-methylpropionate), and di-tert-butyl-2,2′-azobis (2-methylpropionate). It is allowable to use two or more polymerization initiators in combination.

Any process proceeded in a water-base medium can additionally employ an inorganic free radical generator such as persulfate or “redox” compound.

It is still also allowable to appropriately use a chain transfer agent for molecular weight control. The chain transfer agent is used mainly for controlling molecular weight of the polymer. Species and amount of addition of the chain transfer agent can be selected depending on types of the polymerizable monomer. Chain transfer constants of the chain transfer agents for various monomers can be referred to Polymer Handbook (3rd edition, co-edited by J. Brandrup and E. H. Immergut, published by John Wiley & Son). Also the chain transfer constant can experimentally be determined referring to “Kobunshi Gosei no Jikken-ho (Japanese: Experimental Methods in Polymer Synthesis)”; collaborated by Takayuki Otsu and Masaetsu Kinoshita, 1972.

Preferable examples of the chain transfer agent include alkylmercaptans (n-butylmercaptan, n-pentylmercaptan, n-octylmercaptan, n-laurylmercaptan, tert-dodecylmercaptan, etc.), thiophenols (thiophenol, m-bromothiophenol, p-bromothiophenol, m-toluene thiol, p-toluene thiol, etc.), and among these, it is preferable to use alkylmercaptans such as n-octylmercaptan, n-laurylmercaptan and tert-dodecylmercaptan. It is also allowable to use any chain transfer agent having hydrogen atoms in the C—H bonds substituted by deuterium atoms or fluorine atoms. It is still also allowable to use two or more species of chain transfer agents in combination.

Polymerization temperature generally depends on decomposition rate of initiator system, and generally falls in a range from 0 to 200° C., and preferably from 40 to 120° C. Some of the monomer M2 exist in a gaseous form at room temperature, and such monomers are preferably polymerized in a pressure-resistant vessel such as autoclave under a pressure falling in a range from the atmospheric pressure to 50 bar, and particularly 2 to 20 bar.

The copolymer obtained as described in the above is transparent (ultraviolet to near-infrared regions), non-crystalline, and soluble to general solvents (in particular in THF and ethyl acetate). Content of the unit P1 derived from the monomer M1 falls in a range from 1 to 99 mol %, preferably from 20 to 80 mol %, and more preferably from 30 to 70 mol %. Molecular weight of the copolymer falls in a range from 1,000 to 1,000,000 on the number average molecular weight basis (styrene-based number average molecular weight measured by gel permeation chromatography), preferably from 2,000 to 900,000, and more preferably from 3,000 to 800,000. Glass transition point (Tg) of the copolymer preferably falls in a range from 60 to 180° C., preferably 70 to 180° C., and more preferably 80 to 180° C. The glass transition point is mainly related to content of the unit P1 contained in the copolymer. Also transparency of the obtained copolymer depends on content of the unit P1.

The copolymer of the present invention is useful as a material for optical members. Examples of the optical members containing the copolymer of the present invention include optical fiber (in-vehicle optical fiber included); photoconductive elements such as optical waveguide; lenses for still camera, video camera, telescope, eyeglasses, plastic contact lens, and solar collector; mirrors such as concave mirror and polygon mirror; and prisms such as pentaprism. The copolymers having an extremely small birefringence may be obtained by copolymerization of high-heat-resistant and low-hygroscopic monomers, and, thus, such copolymers are also applicable to diffuser plate, substrate for optical disc, and optical switch. The copolymer is preferably applicable to photoconductive elements, lenses and mirrors, and more preferably applicable to optical fibers, optical waveguides and lenses. Although embodiments relating to optical fibers, which are preferred embodiments, will be described in detail hereinafter, the copolymer of the present invention is preferably applicable to any other optical members.

The following paragraphs will describe embodiments of the process of producing the optical member applied with the copolymer of the present invention. The embodiments described below relate to plastic optical members comprising a core produced by using the copolymer of the present invention. The cladding portion thereof may preliminarily be prepared as a pipe-formed member within which the core portion is formed later by a process described below, or may be added around the core portion preliminarily formed by a method described below. A perform of a plastic optical fiber can be produced typically by the processes described below using a solution or solid of the copolymer (Process (1) is described in Japanese Laid-Open Patent Publication No. 11-109144, p. 7 “Hatsumei no Jisshi no Keitai (Japanese: Preferred Modes of Embodiment of the Present Invention)”), without limiting the present invention:

Process (1):

A process for producing a preform (PF) comprising:

placing a refractive index adjustor, or a mixture of the copolymer of the present invention and a refractive index adjustor in the center or on the circumferential portion of a mold product formed of polymer, and

allowing the refractive index adjustor to thermally diffuse thereto; or

stacking a plurality of molten resin layers containing the refractive index adjustor in a different amount each other, and

allowing the refractive index adjustor to diffuse between each adjacent layers.

Process (2):

A process for producing a preform (PF) comprising:

pouring a solution of the copolymer of the present invention, optionally with a refractive index adjustor, into a hollow portion of a glass pipe or a hollow tube formed of a low-refractive-index material to become a cladding portion, and

allowing the organic solvent to evaporate under rotation by reduced pressure or heating, to thereby form a portion formed of the copolymer while gradually varying concentration of the refractive index adjustor in the solution.

A process (3):

A process for producing a preform (PF) comprising:

pouring a polymerizable composition (monomer, polymerization initiator, optional chain transfer agent, and optional refractive index adjustor) capable of giving the copolymer of the present invention (preferably a copolymer having a refractive index different from, and larger than that of the thermoplastic resin, ensuring difference in the refractive index of 0.001 or larger, preferably 0.005 or larger, and more preferably 0.01), into a hollow portion of a glass pipe or a hollow tube formed of a low-refractive-index material to become a cladding portion, and

allowing the composition to polymerize with the aid of heat or light.

Process (4)

A process for producing a preform (PF) comprising:

allowing the polymerizable compositions to step-wisely polymerize in the process (3), to thereby fabricate a hollow preform composed of a plurality of concentric rotation-polymerized layers, while gradually varying the refractive index towards the center by using a plurality of monomers having different refractive indices and combinations thereof.

The above described processes are employed for producing the core portion having a refractive index graded typically in the direction of section thereof. If there is no need of forming such distribution in the refractive index, it is all enough to produce a preform so as to form a polymer matrix containing no refractive index adjustor, or being composed of a copolymer uniform in the sectional direction, in the processes described in (1) to (4) in the above.

The thermoplastic resin used for the cladding portion in the above-described processes may be anything provided that it can ensure a sufficiently large level of strength under temperature of use of the plastic optical fiber, and preferably has a tensile elasticity at room temperature of 2,000 MPa or above. Among these, particularly representative examples include polymethyl methacrylate resins, polycarbonate resins, linear polyester resins, polyamide resins, AS (acrylonitrile/styrene copolymer) resins, ABS resins, polyacetal resins, cyclic polyolefin resins, polystyrene resins, tetrafluoroethylene copolymer resins, and chlorotrifluoroethylene copolymer resins.

The refractive index adjustor is also referred to as dopant, and is a compound having a refractive index different from that of the polymer or polymerizable monomers used in combination therewith. Difference in the refractive index is preferably 0.005 or larger. The dopant has a property of raising the refractive index of the polymer containing thereof, as compared with that of the dopant-free polymer. Any compounds capable of ensuring difference in the solubility parameter, in comparison with the polymer synthesized from the monomers, of as small as 7 (cal/cm³)^{1/2} or less, and difference in the refractive index as large as 0.001, capable of altering the refractive index of the polymer containing thereof, as compared with that of the dopant-free polymer, capable of stably co-existing with the polymer, and being stable under polymerization conditions (those for heating, pressurizing and so forth) for the polymerizable monomers which are the above-described source materials, as described in Japanese Patent No. 3332922 and Japanese Laid-Open Patent Publication No. 5-173026, are applicable.

The dopant may be a polymerizable compound. For the case where a polymerizable dopant is used, it is preferable that the copolymer containing the dopant as the co-polymerizable component can raise the refractive index larger than that of the dopant-free polymer. In the present invention, it is also allowable to select a plurality of monomers differing from each other in the refractive index, and to form an index-graded core portion by gradually varying the compositional ratios thereof. It is also allowable to use, as the dopant, any compounds having the above-described properties, capable of stably co-existing with the polymer, and being stable under polymerization conditions (those for heating, pressurizing and so forth) for the polymerizable monomers which are the above-described source materials. Formation of the index-graded core portion using the dopant can yield an index-graded plastic optical member having a wide transmission band width.

The dopant can be exemplified by those described in Japanese Patent No. 3332922 and Japanese Laid-Open Patent Publication No. 11-142657, examples of which include benzyl benzoate (BEN), diphenyl sulfide (DPS), triphenyl phosphate (TPP), benzyl n-butyl phthalate (BBP), diphenyl phthalate (DPP), biphenyl (DP), diphenyl methane (DPM), tricresyl phosphate (TCP), diphenyl sulfoxide (DPSO), diphenylsulfide, bis(trimethylphenyl)sulfide, diphenyl sulfide derivatives, dithiane derivatives, 1,2-dibromotetrafluorobenzene, 1,3-dibromotetrafluorobenzene, 1,4-dibromotetrafluorobenzene, 2-bromo-3,4,5,6-tetrafluoro-benzotrifluoride, chloropentafluorobenzene, bromopentafluorobenzene, iodopentafluorobenzene, decafluorobenzophenone, perfluoroacetophenone, perfluorobiphenyl, chloroheptafluoronaphathalene, and bromoheptafluoronaphthalene. The diphenyl sulfide derivatives and dithiane derivatives can appropriately be selected from the compounds specifically shown below. Among others, BEN, DPS, TPP, DPSO and diphenyl sulfide derivatives are preferable. Also the compounds having hydrogen atoms contained therein substituted by deuterium atoms may be used for the purpose of improving the transparency over a wider wavelength range. The polymerizable compounds can be exemplified by tribromophenyl methacrylate. Use of the polymerizable compound as the refractive index adjustor may make it difficult to control various characteristics (in particular optical characteristic), because the matrix thereof is formed by co-polymerizing the polymerizable monomers and polymerizable refractive index adjustor, but may raise an advantage in terms of heat resistance.

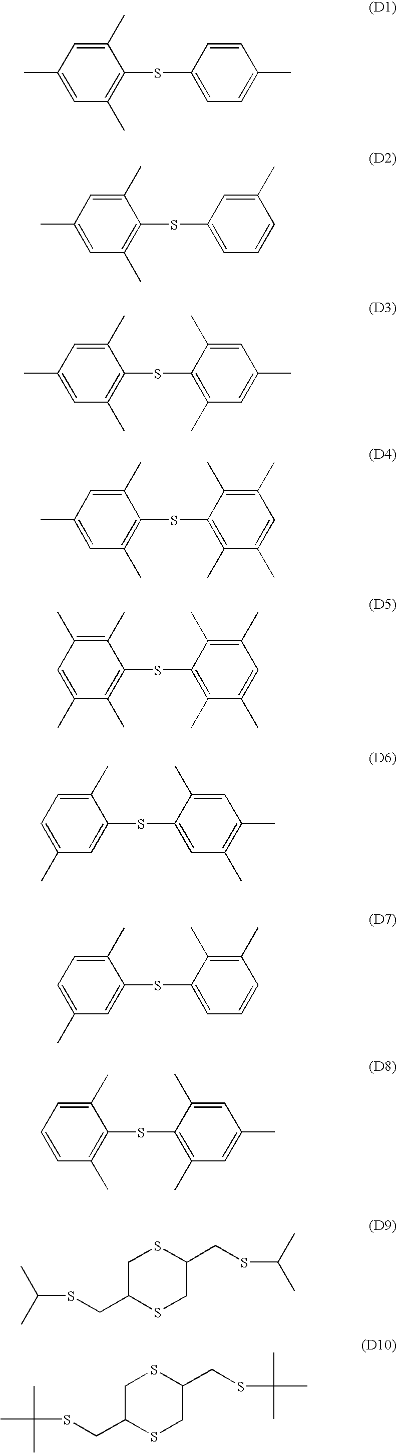

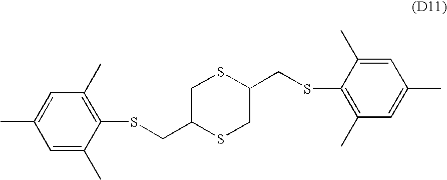

For the purpose of using the copolymer of the present invention for the core portion, the monomer more preferably contains a smaller amount of C—H bond in view of reducing the transmission loss, and more preferably has C—H bond substituted by C-D bond. The monomer M2 for forming the polymer preferably has fluorine atom(s). The monomer may occasionally reduce the refractive index by containing fluorine atoms, so that the core portion in this case may be added with the dopant. From this point of view, combinations of the copolymer of the present invention and the dopant, preferable for producing the core portion, include a combination of 1,4-dioxenechloro-trifluoroethylene copolymer (number average molecular weight=28,000, Tg=150° C., refractive index (n)=1.459) as the core polymer, and diphenylsulfide (n=1.633) as the dopant; and a combination of 1,4-dioxene-2-trifluoromethyl trifluoroethyl acrylate copolymer (number average molecular weight=22,000, Tg=158° C., refractive index (n)=1.443) as the copolymer and diphenylsulfide (n=1.633) as the dopant.

A process of producing the core portion having a refractive index distribution of the graded-index (GI) type using the above-described dopant and the copolymer of the present invention is preferably such as starting with the polymerization of the monomers, which is preferable as a method of controlling a distribution profile of refractive index, whereas any of the above-described methods are applicable through adjustment of conditions depending on suitability of the copolymer of the present invention to the producing processes. The present invention is, however, not limited to these methods.

It is also allowable to add any other additives so far as they do not degrade the light transmission performance. For example, a stabilizer can be added for the purpose of improving the weatherability and durability. It is still also allowable to add a compound having an induced emission function for amplifying light signals, for the purpose of improving the light transmission performance. Addition of this sort of compounds makes it possible to amplify attenuated signal light with an excitation light and thereby to improve transmission distance, so that the copolymer can be used typically for a fiber amplifier as a part of a light transmission link. Also these additives can be included in the copolymer by adding them to the source monomers, and then allowing the source monomers to polymerize.

The plastic optical fiber can be fabricated by stretching a preform in a melted state. The stretching is preferably carried out by allowing the preform to pass through an annealing furnace (cylindrical annealing furnace, for example) to thereby heat and melt it, which is followed by continuously stretching the preform so as to form a fiber. Temperature of heating can appropriately be determined depending on materials composing the preform, and preferably adjusted to a range from 180 to 250° C. in general. Conditions for the stretching (temperature of stretching, etc.) can appropriately be determined depending on the diameter of the obtained preform, desired diameter of the plastic optical fiber, and materials employed. In particular for the index-graded optical fiber, having a sectional structure in which the refractive index varies from the center towards the circumference, it is necessary to uniformly heat and stretch the preform so as not to destruct the distribution. For the purpose of heating the preform, it is therefore preferable to use a cylindrical annealing furnace capable of uniformly heating the preform in the sectional direction thereof. The heating furnace preferably has a temperature distribution in the direction of axis of stretching. Narrower melted portion is more preferable in view of suppressing deformation of the distribution profile of refractive index and of raising the production yield. More specifically, it is preferable to preheat or slowly cool the zones front and behind the melting zone so as to narrow the melted portion. A heat source used for the melting zone is more preferably a source capable of supplying a high output energy to a narrow portion, such as a laser.

As described in the above, some cases are successful in obtaining a hollow preform depending on the fabrication method. The preform having this sort of geometry is preferably stretched under reduced pressure.

For the fiber keeping the linearity and the circularity, it is preferable to draw the preform into fiber using a draw-spinning apparatus which has an aligning mechanism for keeping the center position constant. The orientation of the polymer in the fiber can be controlled by a drawing condition. And the mechanical properties such as a bending property or thermal shrinkage of the drawn fiber can be also controlled.

The drawing tension can be set to 10 g or above in order to orient molten plastic as described in JPA No. 1995-234322, and preferably set to 100 g or below so that strain does not remain after the spinning as disclosed in JPA No. 1995-234324. It is also allowable to employ a method having a pre-heating step prior to the drawing.

The bending property and the edgewise pressure property of the fiber can be improved when the breaking stretch and the hardness of a raw fiber would be respectively within a range described in JPA No. 1995-244220. The transmission quality of the fiber can be improved when the fiber has an outer layer, having a low refractive index, which can function as a reflective layer, as described in JPA No. 1996-54521.

The plastic optical fiber after being processed in the third step can directly be subjected, without any modification, to various applications. The fiber may also be subjected to various applications in a form of having on the outer surface thereof a covering layer or fibrous layer, and/or in a form having a plurality of fibers bundled for the purpose of protection or reinforcement. For the case where a coating is provided to the element wire, the covering process is such that running the element wire through a pair of opposing dies which has a through-hole for passing the element fiber, filling a molten polymer for the coating between the opposing dies, and moving the element fiber between the dies. The covering layer is preferably not fused with the element fiber in view of preventing the inner element fiber from being stressed by bending. In the covering process, the element fiber may be thermally damaged typically through contacting with the molten polymer. It is therefore preferable to set the moving speed of the element fiber so as to minimize the thermal damage, and to select a polymer for forming the covering layer which can be melted at a low temperature range. The thickness of the covering layer can be adjusted in consideration of fusing temperature of polymer for forming the covering layer, drawing speed of the element fiber, and cooling temperature of the covering layer.

Other known methods for forming the covering layer on the fiber include a method by which a monomer coated on the optical member is polymerized, a method of winding a sheet around, and a method of passing the optical member into a hollow pipe obtained by extrusion molding.

Coverage of the element fiber enables producing of plastic optical fiber cable. Styles of the coverage include contact coverage in which plastic optical fiber is covered with a cover material so that the boundary of the both comes into close contact over the entire circumference; and loose coverage having a gap at the boundary of the cover material and plastic optical fiber. The contact coverage is generally preferable since the loose coverage tends to allow water to enter into the gap from the end of the cover layer when a part of the cover layer is peeled off typically at the coupling region with a connector, and to diffuse along the longitudinal direction thereof. The loose coverage in which the coverage and element fiber are not brought into close contact, however, is preferably used in some purposes since the cover layer can relieve most of damages such as stress or heat applied to the cable, and can thus reduce damages given on the element fiber. The diffusion of water from the end plane is avoidable by filling the gap with a fluid gel-form, semi-solid or powdery material. The coverage with higher performance will be obtained if the semi-solid or powdery material has both of a function for providing water diffusion and a function other than the water-diffusion-providing-function, such as functions for improving heat resistance, mechanical properties or the like.

The loose coverage can be obtained by adjusting position of a head nipple of a crosshead die, and by controlling a decompression device so as to form the gap layer. The thickness of the gap layer can be adjusted by controlling the thickness of the nipple, or compressing/decompressing the gap layer.

It is further allowable to provide another cover layer (secondary cover layer) so as to surround the existing cover layer (primary cover layer). The secondary cover layer may be added with flame retarder, UV absorber, antioxidant, radical trapping agent, lubricant and so forth, which may be included also in the primary cover layer so far as a satisfactory level of the anti-moisture-permeability is ensured.

While there are known resins or additives containing bromine or other halogen or phosphorus as the flame retarder, those containing metal hydroxide are becoming a mainstream from the viewpoint of safety such as reduction in emission of toxic gas. The metal hydroxide has crystal water in the structure thereof and this makes it impossible to completely remove the adhered water in the production process, so that the flame-retardant coverage is preferably provided as an outer cover layer (secondary cover layer) surrounding the anti-moisture-permeability layer (primary cover layer) of the present invention.

It is still also allowable to stack cover layers having a plurality of functions. For example, besides flame retardation, it is allowable to provide a barrier layer for blocking moisture absorption by the element fiber or moisture absorbent for removing water, which is typified by hygroscopic tape or hygroscopic gel, within or between the cover layers. It is still also allowable to provide a flexible material layer for releasing stress under bending, a buffer material such as foaming layer, and a reinforcing layer for raising rigidity, all of which may be selected by purposes. Besides resin, a highly-elastic fiber (so-called tensile strength fiber) and/or a wire material such as highly-rigid metal wire are preferably added as a structural material to a thermoplastic resin, which reinforces the mechanical strength of the obtained cable.

Examples of the tensile strength fiber include aramid fiber, polyester fiber and polyamide fiber. Examples of the metal wire include stainless wire, zinc alloy wire and copper wire. Both of which are by no means limited to those described in the above. Any other protective armor such as metal tube, subsidiary wire for aerial cabling, and mechanisms for improving workability during wiring can be incorporated.

Types of the cable include collective cable having element fibers concentrically bundled; so-called tape conductor having element fibers linearly aligned therein; and collective cable further bundling them by press winding or wrapping sheath; all which can be properly selected depending on applications.

The cables comprising the fibers of the present invention may have a higher tolerance for an axis misalignment than those of the previous cables. Thus, the cables can be used for butt connections, however, in such cases, optical connectors are desirably used at the ends, so as to fix the connection portions certainly. Various types of commercially available connectors such as a PN, SMA, SMI, F05, MU, FC or SC type connector can be used.

The optical member of the present invention is available as an optical fiber cable for use in a system for transmitting light signal, which system comprises various light-emitting element, light-switch, optical isolator, optical integrated circular, light-receiving element, other optical fiber, optical bus, optical star coupler, light signal processing device, optical connector for connection and so forth. Any known technologies may be applicable while making reference to “Purasuchikku Oputicaru Faiba no Kiso to Jissai (Basics and Practice of Plastic Optical Fiber)”, published by N.T.S. Co., Ltd.; pages 110 to 127 of “NIKKEI ELECTRONICS” vol. 2001, 12, 3 or the like. The optical member of the present invention may be combined with any technology described in the above mentioned documents, and the combinations may form light transmission systems for short distance such as high-speed data communications or controls without electro magnetic wave. More specifically, such combinations may form internal wirings in computers or various digital equipments; internal wirings in vehicles or ships; optical links between optical terminals and digital equipments or between digital equipments; and indoor or interregional optical LANs in isolated houses, multiple houses, factories, offices, hospitals, schools.

Furthermore, the optical member of the present invention may be combined with any technique described in “High-Uniformity Star Coupler Using Diffused Light Transmission”, IEICE TRANS. ELECTRON., VOL. E84-C, No. 3, MARCH 2001, p. 339-344; or “HIKARI SHITOBASU GIJYUTSU NIYORU INTACONEKUSYON (Interconnections by optical sheet buses)” Journal of Japan Institute of Electronics Packaging Vol. 3, No. 6, 2000, p. 476-480; optical bus typically described in JPA Nos. 1998-123350, 2002-90571 or 2001-290055; optical branching/coupling device typically described in JPA No. 2001-74971, 2000-329962, 2001-74966, 2001-74968, 2001-318263 or 2001-311840; optical star coupler typically described in JPA No. 2000-241655; light signal transmission device and optical data bus system typically described in JPA No. 2002-62457, 2002-101044 or 2001-305395; light signal processor typically described in JPA No. 2002-23011; light signal cross-connection system typically described in JPA No. 2001-86537; optical transmission system typically described in JPA No. 2002-26815; or multi-function system typically described in JPA No. 2001-339554 or 2001-339555; any light guide, any optical turnout and crossing, any optical coupler, any optical compiling filter or any optical branching filter; and such combinations may form improved optical transmission systems using multiple sending and receiving.

Outside of the above mentioned applications, the optical member of the present invention may be used in the various technical fields such as lighting systems, energy transmitters, illuminations or sensors.

### EXAMPLE

The present invention will specifically be described referring to the specific examples. It is to be noted that any materials, reagents, ratio of use, operations and so forth can be properly altered without departing from the spirit of the present invention. The scope of the present invention is therefore by no means limited to the specific examples shown below.

It is noted that “part” and “%” hereinafter means those based on mass unless stated.

[Exemplary Monomer Synthesis 1]

### Exemplary Synthesis of Compound (M1-10)

The next paragraphs will detail an exemplary synthesis of compound (M1-10). A synthetic route is shown by the reaction formula below:

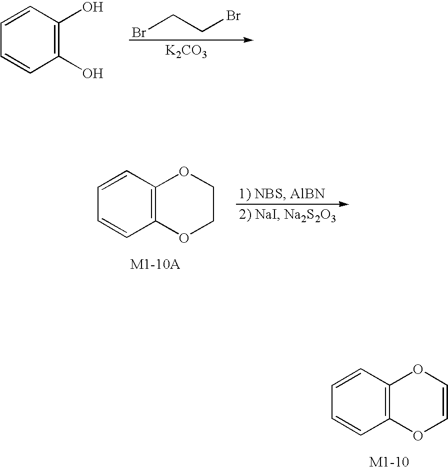

### Synthesis of Benzodioxane (M1-10A):

To 550 ml of an ethylene glycol solution containing 54 g (0.49 mol) of catechol and 188 g (1.00 mol) of 1,2-dibromoethane, added was 144 g (1.04 mol) of potassium carbonate, and stirred at 120 to 130° C. for 4 hours under a nitrogen atmosphere. The mixture was cooled to room temperature, added with 500 ml of distilled water and 700 ml of dichloroethane to separate into two layers, the organic layer (lower layer) was washed with a 5% aqueous sodium hydrogen carbonate solution and a saturated saline once each, and dried over anhydrous sodium sulfate. After the solvent is removed under reduced pressure, the residue was purified by distillation (6 mmHg, 103° C.), to thereby give 57 g of colorless clear liquid 1-2A (yield: 62%).

¹H-NMR (300 MHz, CDCl₃) data are shown below:

δ4.25 (s, 4H), 6.7-7.0 (m, 4H)

Synthesis of Benzodioxin (M1-10):

To 700 ml of a carbon tetrachloride solution containing 50.0 g (0.37 mol) of benzodioxane (1-2A), added were 171 g (2.6 eq) of N-bromosuccimide (NBS) and 3.0 g (5 mol %) of 2,2′-azobisisobutylonitrile (AIBN), and refluxed for 10 hours under a nitrogen atmosphere. The mixture was cooled to room temperature, solid content was filtered off, the filtrate was added with 500 ml of distilled water to separate into two layers, the organic layer (lower layer) was washed with a saturated saline and dried over anhydrous sodium sulfate. The solvent was distilled off under reduced pressure, added with 220 g (4 eq) of sodium iodide and 1.2 L of acetone, and the mixture was refluxed for four hours under a nitrogen atmosphere. As much as 600 ml of acetone was distilled off, the residual mixture was added with 1 L of a 1.5 mol/L aqueous sodium thiosulfate (Na₂S₂O₃) solution, stirred for 10 min at room temperature, and extracted using 1.5 L of dichloromethane. The extract was washed with a saturated saline, the solvent was distilled off, the residue was purified by column chromatography (eluted with hexane) and by distillation (23 mmHg, 86° C.), to thereby give 38.5 g of colorless clear liquid (1-2A) (yield: 52%).

¹H-NMR (300 MHz, CDCl₃) data are shown below:

δ5.84 (s, 2H), 6.6 (m, 2H), 6.8 (m, 2H)

### Example 1

### Exemplary Preparation of Copolymer (P-3)

A 100-mL autoclave was charged with 24 parts of ethyl acetate, 20 parts of 1,4-dioxene (M1-1: product of Tokyo Kasei Kogyo Co., Ltd.), and 0.3 parts of tert-butylperoxypivalate (product of NOF Corporation), and the residual capacity was replaced with nitrogen. Next, 31 parts of chlorotrifluoroethylene (product of Daikin Industries, Ltd.) was further charged, and the content was allowed to polymerize at 55° C. for 13 hours under stirring. After the polymerization, the pressure was recovered to normal pressure, and the lid was opened. It was found that the polymer solution was saturated, and a part of the polymer separated out. The polymer, which separated out, was dissolved into 150 mL of tetrahydrofuran (THF), the solution was mixed with the ethyl acetate solution, and the product was purified by re-precipitation in methanol. The re-precipitation was repeated twice, to thereby give 35 g of a fluorine-containing copolymer having Tg of 154° C., number average molecular weight (Mn) of 28,000, and refractive index (n) of 1.459. The obtained polymer was found to be an exemplary polymer P-3. The polymer was soluble in ethyl acetate, tetrahydrofuran (THF) and so forth. The obtained polymer (P-3) was dissolved into THF, coated on a slide glass, and the solvent (THF) was removed initially in the air, and then evaporated off under reduced pressure. The obtained film was completely transparent.

### Example 2

### Exemplary Preparation of Copolymer (P-11)

A 20-mL test tube was charged with 2 parts of 1,4-dioxene (M1-1: product of Tokyo Kasei Kogyo Co., Ltd.), 5.15 parts of trifluoroethyl 2-trifluoromethylacrylate (product of TOSOH Corporation), and 0.0082 parts of tert-butylperoxyisopropyl monocarbonate (product of NOF Corporation), the residual capacity was replaced with argon, and the mixture was allowed to polymerize at 90° C. for 20 hours without stirring. The obtained rod-formed polymer was dissolved into THF, poured into hexane, purified by re-precipitation repeated twice, to thereby give 4.1 g of a fluorine-containing copolymer (P-11) having Tg of 158° C., and number average molecular weight (Mn) of 39,000. The polymer was soluble in ethyl acetate, tetrahydrofuran (THF) and so forth. The polymer (P-11) was dissolved into THF, coated on a slide glass, and the solvent (THF) was removed initially in the air, and then evaporated off under reduced pressure. The obtained film was completely transparent.

### Example 3

### Exemplary Preparation of Copolymer (P-19)

A 20-mL test tube was charged with 16.4 parts of 1,4-dioxene (M1-1: product of Tokyo Kasei Kogyo Co., Ltd.), 50.6 parts of heptafluoropropyl trifluorovinyl ether (product of Asahi Glass Co., Ltd.), 26.7 parts of ethyl acetate, and 0.375 parts of tert-butylperoxyisopropyl monocarbonate (product of NOF Corporation), the residual capacity was replaced with argon, and the mixture was allowed to polymerize at 55° C. for 20 hours without stirring. The obtained rod-formed polymer was dissolved into ethyl acetate, poured into methanol and purified by re-precipitation repeated twice, to thereby obtain 36.1 g of a fluorine-containing copolymer (P-19) having Tg of 150° C., and number average molecular weight (Mn) of 12,000. The polymer was soluble in ethyl acetate, tetrahydrofuran (THF) and so forth. The polymer (P-19) was dissolved into THF, coated on a slide glass, and the solvent (THF) was removed initially in the air, and then evaporated off under reduced pressure. The obtained film was completely transparent.

### Example 4

### Exemplary Preparation of Copolymer (P-37)

A 100-mL autoclave was charged with 24 parts of ethyl acetate, 20 parts of benzodioxin (M1-10: synthesized in the above-described Exemplary Synthesis), and 0.3 parts of tert-butylperoxypivalate (product of NOF Corporation), and the residual capacity was replaced with nitrogen. Next, 31 parts of chlorotrifluoroethylene (product of Daikin Industries, Ltd.) was further charged, and the content was allowed to polymerize at 55° C. for 13 hours under stirring. After the polymerization, the pressure was recovered to normal pressure. The polymer, which separated out, was dissolved into 150 mL of tetrahydrofuran (THF), the solution was mixed with the ethyl acetate solution, and the product was purified by re-precipitation in hexane. The re-precipitation was repeated twice, to thereby give 15.2 g of a fluorine-containing copolymer (P-37) having Tg of 125° C., and weight average molecular weight (Mw) of 27,000. The polymer was soluble into ethyl acetate, tetrahydrofuran (THF) and so forth. The polymer (P-37) was dissolved into THF, coated on a slide glass, and the solvent (THF) was removed initially in the air, and then evaporated off under reduced pressure. The obtained film was completely transparent.

### Example 5

### Exemplary Preparation of Copolymer (P-45)

A 20-mL test tube was charged with 1.34 parts of benzodioxin (M1-10: synthesized in the above-described Exemplary Synthesis), 2.22 parts of trifluoroethyl 2-trifluoromethylacrylate (product of TOSOH Corporation), and 0.0082 parts of tert-butylperoxyisopropyl monocarbonate (product of NOF Corporation), the residual capacity was replaced with argon, and the mixture was allowed to polymerize at 90° C. for 20 hours without stirring. The obtained rod-formed polymer was dissolved into THF, poured into hexane and purified by re-precipitation repeated twice, to thereby give 4.1 g of a fluorine-containing copolymer (P-45) having Tg of 110° C., and weight average molecular weight (Mw) of 22,000. The polymer was soluble into ethyl acetate, tetrahydrofuran (THF) and so forth. The polymer (P-45) was dissolved into THF, coated on a slide glass, and the solvent (THF) was removed initially in the air, and then evaporated off under reduced pressure. The obtained film was completely transparent.

### Comparative Example 1

A 100-mL autoclave was charged with 24 parts of ethyl acetate, 20 parts of 1,4-dioxene (product of Tokyo Kasei Kogyo Co., Ltd.) and 0.3 parts of tert-butylperoxypivalate (product of NOF Corporation), and the residual capacity was replaced with nitrogen. Next, 13 parts of ethylene having an e value of −0.2 was further charged, and the content was allowed to polymerize at 55° C. for 13 hours under stirring. After the polymerization, the pressure was recovered to normal pressure, and the lid was opened, only to find no polymer formed therein.

### Example 6

### Exemplary Production of Copolymer (P-10) Step-Index-Type Optical Fiber

In a polyvinylidene fluoride (refractive index: 1.42) hollow, pipe produced by molten extrusion molding (also the bottom made of polyvinylidene fluoride), charged were 40 parts of 1,4-dioxene (product of Tokyo Kasei Kogyo Co., Ltd.), 72 parts of methyl 2-trifluoromethyl acrylate (synthesized from 2-trifluoromethyl acrylate which is product of TOSOH Corporation) having an e value of 2.9, and 0.16 parts of tert-butylperoxyisopropyl monocarbonate (product of NOF Corporation), the residual capacity was replaced with argon, and the mixture was allowed to polymerize at 90° C. for 20 hours without stirring, and further at 120° C. for 24 hours. The obtained preform was directly stretched under melting at 240° C., to thereby give a stepped-index-type optical fiber element. Transmission loss of at 660 nm was found to be 180 dB/km.

### Example 7

### Exemplary Preparations of Graded-Index Optical Fibers using a plurality of Monomers (M1-1, M1-10 and M2-13)

Using a rotary polymerization device with a glass tube, a plurality of layers (9 layers herein) were sequentially formed by rotary polymerization (65° C. at 1,200 rpm to 3,000 rpm) with V-601 as a polymerization initiator (product of Wako Pure Chemical Industries, Ltd.) from the outermost layer towards the center according to the monomer ratios (molar ratios) shown below, to thereby give an index-graded hollow preform (PF). Transmission loss of at 660 nm was found to be 190 dB/km.

| | M1-1 | M1-10 | M2-13 |
|---|---|---|---|
| Outermost layer | 100 | 0 | 100 |
| 2nd layer | 97 | 3 | 100 |
| 3rd layer | 94 | 6 | 100 |
| 4th layer | 92 | 8 | 100 |
| 5th layer | 90.5 | 9.5 | 100 |
| 6th layer | 89.5 | 10.5 | 100 |
| 7th layer | 88.5 | 11.5 | 100 |
| 8th layer | 88 | 12 | 100 |
| Innermost layer | 87.5 | 12.5 | 100 |

### INDUSTRIAL APPLICABILITY

According to the present invention, a novel copolymer exhibiting a wet-heating resistance and a non-crystalline property can be provided. And an optical member exhibiting a good heat resistance and good optical characteristics can be also provided.

### CROSS-REFERENCE TO RELATED APPLICATIONS

This application claims benefit of priority to Japanese Patent Application No. 2004-186199 filed Jun. 24, 2004.

1. A copolymer comprising 1 to 99 mol % of at least one
repetitive unit (P1) represented by the formula (1) below: formula (1) 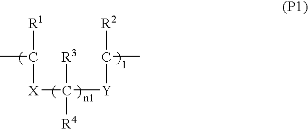
where R¹ and R² respectively represent a hydrogen atom (H), a deuterium atom (D), a halogen atom, a substituted or non-substituted alkyl group or a substituted or non-substituted aryl group; R³ and R⁴ respectively represent a hydrogen atom (H), a deuterium atom (D), a halogen atom, a cyano group, a nitro group or a substituted or non-substituted alkyl group, aryl group, alkoxy group, aryloxy group, heterocyclic oxy group, alkoxy or aryloxycarbonyl group, alkyl or arylcarbonyloxy group, carbamoyl group, alkyl or arylaminocarbonyl group, acylamino group, alkyl or arylcarbonylamino group, alkoxy or aryloxycarbonyloxy group, alkoxy or aryloxycarbonylamino group, alkyl or arylsulfonylamino group, alkyl or arylthio group, heterocyclic thio group, alkyl or arylsulfinyl group, alkyl or arylsulfonyl group or acyl group; X and Y respectively represent an oxygen atom (O) or sulfur atom (S), n1 represents any one of integers from 2 to 4, and 1 represents the number of repetition of the repetitive unit, provided that at least one of R¹ to R⁴ is not a fluorine atom (F); and 99 to 1 mol % of at least one repetitive unit (P2) represented by the formula (2) below: 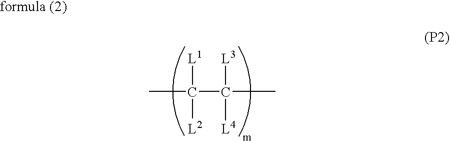
where, L¹ to L⁴ respectively represent a hydrogen atom (H), a deuterium atom (D), a halogen atom, a cyano group, a nitro group or a substituted or non-substituted alkyl group, aryl group, alkoxy group, aryloxy group, alkoxy or aryloxycarbonyl group, alkyl or arylcarbonyloxy group, carbamoyl group, alkyl or arylaminocarbonyl group, acyl group, acylamino group, alkyl or arylcarbonylamino group, alkoxy or aryloxycarbonyloxy group, alkoxy or aryloxycarbonylamino group, or alkyl or arylsulfonylamino group, provided that at least one of L¹ to L⁴ contains one or more fluorine atoms, any two groups selected from L¹ to L⁴ may form a cyclic structure, and m represents the number of repetition of the repetitive unit.

2. The copolymer of claim 1, wherein R¹ and R² in the formula (1) respectively represent a hydrogen atom (H) or deterium atom (D).

3. The copolymer of claim 1, wherein both of X and Y in the formula (1) represent an oxygen atom (O), and nil is 2.

4. The copolymer of claim 1, wherein the repetitive unit (P1) is represented by the formula (5a) below: 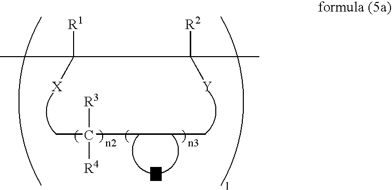
where R¹ to R⁴, and X, Y and 1 are respectively same with those in the formula (1); n2 represents 0 or 1, and n3 represents 1 or 2, excluding the case where n2 is 1 and n3 is 2; and Q represents a substituted or non-substituted aliphatic hydrocarbon ring or aromatic hydrocarbon ring condensed with the main ring.

5. A copolymer, having a molecular weight of 1000 to 1,000,000 (styrene-based number average molecular weight measured by gel permeation chromatography), of 1 to 99 mol % of at: least one monomer (M1) represented by the formula (3) below; 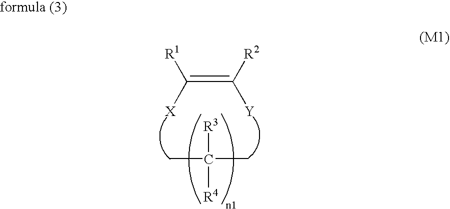
where, R¹ and R² respectively represent a hydrogen atom (H), a deuterium atom (D), a halogen atom, a substituted or non-substituted alkyl group or a substituted or non-substituted aryl group; R³ and R⁴ respectively represent a hydrogen atom (H), a deuterium atom (D), a halogen atom, a cyano group, a nitro group, or a substituted or non-substituted alkyl group, aryl group, alkoxy group, aryloxy group, heterocyclic oxy group, alkoxy or aryloxycarbonyl group, alkyl or arylcarbonyloxy group, carbamoyl group, alkyl or arylaminocarbonyl group, acylamino group, alkyl or arylcarbonylamino group, alkoxy or aryloxycarbonyloxy group, alkoxy or aryloxycarbonylamino group, alkyl or arylsulfonylamino group, alkyl or arylthio group, heterocyclic thio group, alkyl or arylsulfinyl group, alkyl or arylsulfonyl group or acyl group; X and Y respectively represent an oxygen atom (O) or sulfur atom (S); and n1 represents any one of integers from 2 to 4, provided that at least one of R¹ to R⁴ is not a fluorine atom (F);
and 99 to 1 mol % of at least one monomer (M2) represented by the formula (4) below: 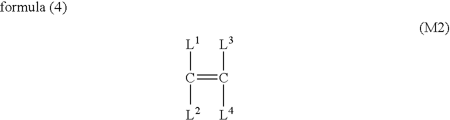
where, L¹ to L⁴ respectively represent a hydrogen atom (H), a deuterium atom (D), a halogen atom, a cyano group, a nitro group, or a substituted or non-substituted alkyl group, aryl group, alkoxy group, aryloxy group, alkoxy or aryloxycarbonyl group, alkyl or arylcarbonyloxy group, carbamoyl group, alkyl or arylaminocarbonyl group, acyl group, acylamino group, alkyl or arylcarbonylamino group, alkoxy or aryloxycarbonyloxy group, alkoxy or aryloxycarbonylamino group, or alkyl or arylsulfonylamino group, provided that at least one of L¹ to L4 contains one or more fluorine atoms, any two groups selected from L¹ to L⁴ may form a cyclic structure.

6. The copolymer of claim 5, wherein R¹ and R² in the formula (3) respectively represent a hydrogen atom (H) or a deuterium. Atom (D).

7. The copolymer of claim 5, wherein both of X and Y in the formula (3) represent an oxygen atom (O), and n1 is 2.

8. The copolymer of claim 5, wherein e-value of the fluorine-containing vinyl monomer (M2) represented by the formula (4) is 0 or larger.

9. The copolymer of claim 5, wherein the monomer (M2) is represented by the formula (5) below: 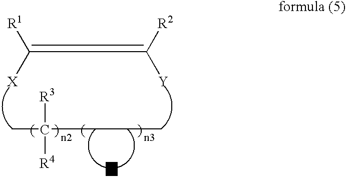
where R¹ to R⁴, and X and Y are respectively same with those in the formula (3); n2 represents 0 or 1, and n3 represents 1 or 2, excluding the case where n2 is 1 and n3 is 2; and Q represents a substituted or non-substituted aliphatic hydrocarbon ring or aromatic hydrocarbon ring condensed with the main ring.

10. the copolymer of claim 5, wherein the monomer (M2) at least one selected from Group I below:

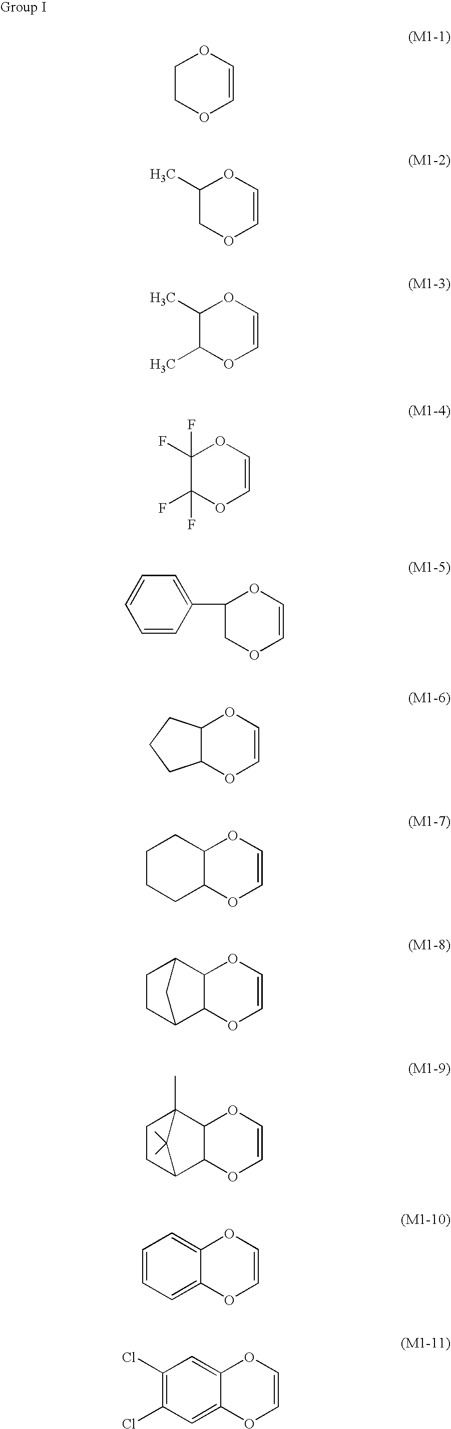

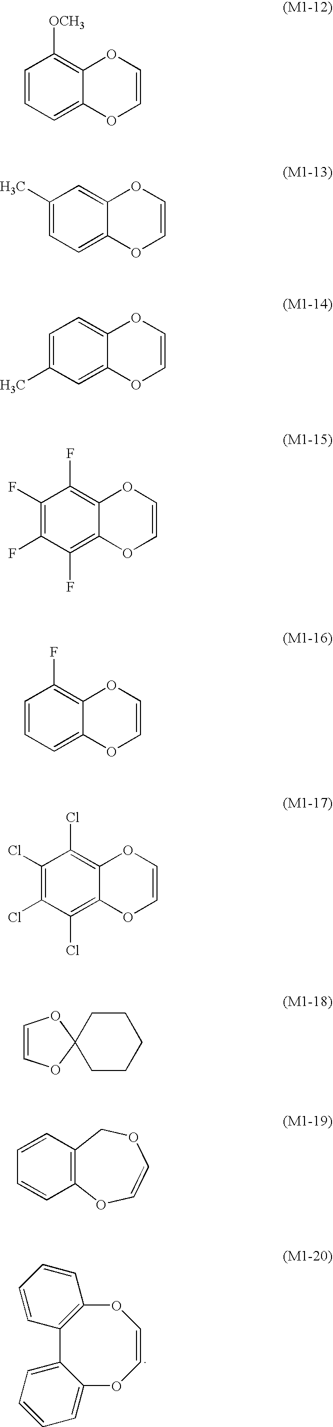

11. The copolymer of claim 5, wherein the monomer (M2) is at least one selected from Compound M1-1 and Compound M1-10 below:

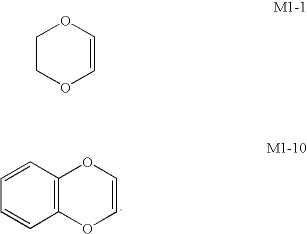

12. A process for producing an optical member comprising carrying out polymerization of 1 to 99 mol % of at least one monomer (M1) represented by the formula (3) below; 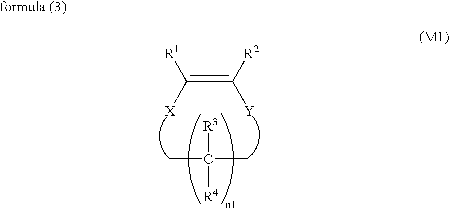
where, R¹ and R² respectively represent a hydrogen atom (H), a deuterium atom (D), a halogen atom, a substituted or non-substituted alkyl group or a substituted or non-substituted aryl group; R³ and R⁴ respectively represent a hydrogen atom (H), a deuterium atom (D), a halogen atom, a cyano group, a nitro group, or a substituted or non-substituted alkyl, aryl group, alkoxy group, aryloxy group, heterocyclic oxy group, alkoxy or aryloxycarbonyl group, alkyl or arylcarbonyloxy group, carbamoyl group, alkyl or arylaminocarbonyl group, acylamino group, alkyl or arylcarbonylamino group, alkoxy or aryloxycarbonyloxy group, alkoxy or aryloxycarbonylamino group, alkyl or arylsulfonylamino group, alkyl or arylthio group, heterocyclic thio group, alkyl or arylsulfinyl group, alkyl or arylsulfonyl group or acyl group; X and Y respectively represent an oxygen atom (O) or sulfur atom (S); and n1 represents any one of integers from 2 to 4, provided that at least one of R¹ to R⁴ is not a fluorine atom (F);
and 99 to 1 mol % of at least one monomer (M2) represented by the formula (4) below: 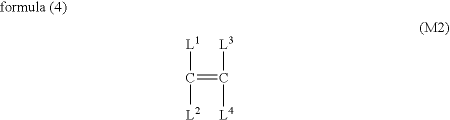
where, L¹ to L⁴ respectively represent a hydrogen atom (H), a deuterium atom (D), a halogen atom, a cyano group, a nitro group, or a substituted or non-substituted alkyl group, aryl group, alkoxy group, aryloxy group, alkoxy or aryloxycarbonyl group, alkyl or arylcarbonyloxy group, carbamoyl group, alkyl or arylaminocarbonyl group, acyl group, acylamino group, alkyl or arylcarbonylamino group, alkoxy or aryloxycarbonyloxy group, alkoxy or aryloxycarbonylamino group, or alkyl or arylsulfonylamino group, provided that at least one of L¹ to L4 contains one or more fluorine atoms, any two groups selected from L¹ to L⁴ may form a cyclic structure; to form a copolymer having a molecular weight of 1,000 to 1,000,000 (styrene-based number average molecular weight measured by gel permeation chromatography).

13. An optical member comprising at least one region comprising a copolymer as set forth in claim 5 as a major component.

14. The optical member of claim 13, wherein the region comprises at least a first layer and a second layer, the first layer comprises the copolymer of the monomer (M1) and the monomer (M2) in a molar ratio r1, the second layer comprises the copolymer of the monomer (M1) and the monomer (M2) in a molar ratio r2, which is not equal to r1, and the refractive indices of the first and second layers are different each other based on a difference between the r1 and the r2.

15. An optical member comprising at least one region comprising a copolymer as set forth in claim 1 as a major component.
